(19) United States
(12) Patent Application Publication
(10) Pub. No.: US 2007/0249273 A1
(43) Pub. Date: Oct. 25, 2007

(54) Foam Dispensing and Delivery System and Method

(76) Inventor: Ray Francis, Stevensville, MD (US)

Correspondence Address: SCHIFF HARDIN, LLP;PATENT DEPARTMENT, 6600 SEARS TOWER, CHICAGO, IL, 60606-6473, US

(21) Appl. No.: 11/670,870

(22) Filed: Feb. 2, 2007

(51) Int. Cl. A22B 3/00; A22B 5/04

(52) U.S. Cl. 452/66

(57) ABSTRACT

A system and appertaining methods for producing the system and operating the system permit depopulating large areas of infected poultry by providing a movable high-volume foam generation system. The water-based foam generated by the system produces a dense and non-toxic foam that creates rapid asphyxiation in animals. The foam then dissipates after a relatively brief period of time. The system comprises a portable trailer with a water pump, foam chemicals and chemical injection system. These are combined and provided to a hose attached to a carriage that is towed through the facility, the carriage comprising the high-volume foam generation systems.

### BACKGROUND

The present invention relates to an automated foam dispensing and delivery system and method. An embodiment of the invention may be utilized to depopulate animal houses in the event of, e.g., the discover of an infection.

Recent outbreaks of the “Bird Flu” (Avian Influenza and Avian Influenza A (H5N1)) virus outside the U.S. have heightened the possibility of an epidemic in the North American continent. The deadly H5N1 strain of the avian influenza virus is currently understood to be carried by wild fowl such as geese, ducks, and other birds, and is thought at risk of spreading by exposure of domestic fowl to these wild bird populations as they migrate via the “flyways” that bring populations of wild birds south from the Arctic regions into Canada and the United States every year. The H5N1 virus is known to spread from avian populations to humans by human contact with infected birds. Although much more widespread in Asia than the United States, the possibility remains for a substantial outbreak in North America. In the event that such an outbreak occurs, it is of utmost importance to identify the source of the outbreak and to eliminate as many potentially infected animals as possible, before the disease can spread. Neither is this necessity limited to incidences of avian influenza: any dangerous pathogen that threatens animal and/or human populations must be controlled quickly at its outbreak, and existing methods for controlling such outbreaks are limited.

One primary potential source of pathogenic infections, such as avian influenza, are poultry houses in which millions of chickens are bred and raised each year for sale to food companies and consumers. Commercial producers face an enormous challenge in safely and quickly destroying infected broiler populations. Although guidelines are still being developed, some regions suggest depopulation of every facility in a two-mile radius of an infection. In areas where domestic poultry populations are high, this could mean depopulating up to 100 houses and over 2.5 million birds, according to the Delmarva Poultry Industry. A general consensus exists in the commercial poultry business that diseased flocks should be destroyed quickly and efficiently with as little risk to personnel as possible.

Various techniques have been adopted to effect mass depopulation of a flock or animal population that is infected with a dangerous pathogen. In one depopulation system, so-called “whole-house CO₂”, chickens are asphyxiated with carbon dioxide gas, which is pumped into poultry houses. In order to maximize the efficiency of this technique, the poultry houses must be sealed, and multiple personnel (as many as 25, all wearing protective clothing, masks, and goggles) are needed to implement this procedure. This method is expensive due to the cost of the gas and the labor involved, and it is difficult to work with. Another mass depopulation method that is a variation of the method above is “poly-tent CO₂”, which involves entering a house, putting gas canisters on the floor, covering the canisters and sick animals with polyethylene plastic sheeting, sealing the edges with weights and/or battens, and reaching through the plastic to open the cocks on the CO₂ tanks, thus releasing the gas. Workers then must move quickly to the exits of the facility, typically by running on the plastic sheeting covering the birds. Exactly as cumbersome as it sounds, this method is laborious, impractical, inexact, and is dangerous for humans, as it can involve prolonged contact with ill and dying animals that may be infected with a highly contagious pathogenic disease, and presents the risk of workers' possibly inhaling unhealthy amounts of CO² gas. Furthermore, the polyethylene sheeting must be destroyed after each use, adding time and cost, and creating an environmental hazard.

Other known methods include live cage-hauling, in which sick or infected animals are brought outside of the poultry house, increasing risk of a wider infection. This method also requires the use of CO₂ gas, involves extensive human contact with infected animals, and demands extraordinary physical labor. Finally, the carcasses must be returned to the house for composting, or must be buried on farms, burned, or hauled to landfills that may charge for taking them or may refuse to take them.

The known methods also include the practice of cervical dislocation, which is a humane and accepted method that requires a worker to dislocate the head and brain stem of the animal from the spinal cord, thus immediately severing the central nervous system and effectively and painlessly killing the animal within seconds; however, this method is impractical in the case of an infected commercial population that could include anywhere from 20,000-40,000 individual birds, requiring hours of stressful physical labor and extensive contact with animals. Other known methods, such as the use of penetrating bolts or shooting animals with shotguns, are also highly dangerous to workers and largely impractical in large commercial houses.

What is needed is a safer, more reliable, and more efficient method for depopulating facilities at which infected birds might be present. One such system and method may utilize a foam generating system capable of rapidly delivering a high volume of asphyxiating foam to a large area while minimizing or eliminating the use of personnel inside the pen with infected animals.

Systems are known in certain industries that generate large amounts of foam in a building for fire suppression. However, these systems generally involve fixed plumbing and other permanent fixtures in buildings such as airplane hangers. It would be prohibitively expensive to utilize such fixed foam delivery systems in every poultry facility, given the very small percentage of these buildings that would ever actually need to utilize them. Therefore, what is needed is a way to portably convey a rapid foam delivery system to a site at which it is needed.

Portable water delivery systems are known that include self-guided “water-reels” that are used for commercial irrigation, such as Kifco's self-retracting Water-Reel® technology, in which a water delivery system is conveyed over an area in an automated manner. Similar mechanisms are utilized in delivery systems for use in the control, suppression, and/or eradication of insect pests and/or harmful viral agent. Moreover, while sprayer solutions have been used for sanitizing and disinfecting poultry facilities, such systems currently use personnel to manually deliver the spray.

However, to date, no one has created a convenient and economical portable delivery system that can rapidly deliver a foam-based product over a large area with minimal involvement of personnel and that can be utilized for the euthanasia of large poultry and other animal populations.

### SUMMARY

The present invention involves various embodiments or systems and methods that rapidly deliver a combined foam and water solution that. Various preferred embodiments of the invention create a medium-expansion non-toxic foam with the requisite volume, height, density, and foam bubble size for the purpose of inducing physical hypoxia in poultry populations while allowing its single operator to minimize contact with animals infected with disease.

According to various embodiments of the invention, a system and method provide for the high-volume delivery of foam chemical agents into commercial facilities for these purposes. These embodiments include mechanisms that can be positioned at one end of a animal pen or facility and can self-retract through the length of the facility and thereafter onto their transportable platform. Advantageously, these embodiments provide for localized mass euthanasia or mass depopulation within poultry or other animal-related facilities and thus mitigate spread of contagion or viral organisms by dispensing medium-expansion foam at a volume and height necessary to achieve euthanasia of other poultry and commercial bird populations such as turkeys, geese, and ducks, and other animal populations. Additionally, these embodiments permit the introduction of requisite amounts of alternative insecticides or anti-bacterial chemicals as needed to sanitize, clean, flush, and otherwise decontaminate animal-breeding or animal-raising facilities.

Various embodiments of the invention incorporate multiple objects that are equal in importance.

A primary object is to provide a medium-expansion foam delivery system that overcomes the clear limitations of existing methods for effecting mass depopulation in poultry houses and commercial animal pens that can include a very large number (40,000 or more) of individual animals.

A second object is to combine elements of equipment developed for other applications such as foam generation for fire suppression, irrigation for agriculture, and chemical delivery for the purpose of cleaning, sanitizing, or decontaminating facilities, for the new and specific purpose of successfully depopulating large commercial poultry facilities and other animal pens while limiting or eliminating human contact with infected animals.

A third object is to provide a foam generation and delivery apparatus that creates foam of the requisite height, volume, density, and bubble size to induce physical hypoxia in poultry and other animal species raised for commercial purposes, including broiler chickens, breeder chickens, poults and capons, ducks and geese, and extending up to full-grown turkeys, although nothing inherently limits the application of the present invention in this regard.

A fourth object is to allow for the rapid generation and delivery of foam into a broiler house or other commercial poultry facility or animal pen so as to allow for the full and complete containment of infection, with no animals needing to be transported outside the facility.

A fifth object is to ensure delivery of a foam with the requisite endurance, or “dwell-time,” to effect mass euthanasia of infected animals, while draining down in sufficient time to allow for rapid carcass disposal through in-house composting, burial, or other means.

A sixth object is to provide an apparatus that is fully transportable, easily deployed, and easy to maintain and service, allowing its use by emergency management personnel, agricultural personnel, local, state and federal agency personnel, and other persons in the event of a pathogen's infecting a local poultry facility and/or poultry population.

A seventh object is to provide a foam delivery apparatus that is adaptable and flexible to a range of other uses by agriculture, including cleaning, sanitizing, disinfecting, decontaminating, and otherwise securing commercial animal breeding and growing facilities from infection by viral agents, harmful bacteria, and insect pests.

By implementing the system and method of the invention, a two-person crew can depopulate most houses in less than an hour, including cleanup, with little or no risk to human operators. There is no need to herd or handle birds, or fence them. The system is 100% effective at inducing physical hypoxia in infected poultry in less than three minutes, on average, and is thus quicker and more efficient in effecting mass depopulation than other depopulation methods and, significantly, does not unduly stress the animals or personnel. Unlike other methods, by providing the system on a self-contained and easily transported trailer, the system can be deployed rapidly, and by virtue of being able to attach to a variety of water sources (tankers, fire trucks, pools, on-farm pumps or irrigation systems, etc.), it is highly versatile as well.

### DESCRIPTION OF THE DRAWINGS

Various embodiments of the invention are illustrated in the drawing figures and accompanying description below.

FIG. 1 is a basic system block diagram illustrating the primary components of the system;

FIG. 2 is an isometric pictorial view of a system according to an embodiment of the invention; and

FIG. 3 is an isometric pictorial view of the foam generator carriage.

### DETAILED DESCRIPTION OF THE PREFERRED EMBODIMENTS

The primary system is a fully transportable apparatus that uniquely combines and configures an internal combustion engine-driven booster pump, a self-retracting water-reel (Kifco's Water-Reel® is an example of a type of water-reel referred to generically below) with an internal combustion engine-driven retraction engine, one or more chemical injection mechanisms, one or more chemical holding tank or tanks, one or more foam generators and/or foam nozzles, a polyethylene hard hose, a movable wheeled platform, and a foam-generating wheeled carriage. The system also includes all related gearing, valving, piping, switches, safety mechanisms, and controls to allow one individual to disseminate and direct a large volume of medium-expansion fire-fighting (e.g.,) foam, which combines water and a low percentage of non-toxic, environmentally-friendly and biodegradable surfactant-based foam chemical to create an effective vapor barrier, thus starving a fire of oxygen.

Typically, this foam is a mixture of water, diethylene glycol monobutyl ether, ethylene glycol, propylene glycol, alkyl sufactes, ethoxylates, and/or various detergent or solvent mixtures. One such mixture includes 25-35% water, 3-6% diethylene glycol monobutyl ether, and 12-17% ethylene glycol (percentages by weight), such as that identified by Chemguard's product number PC2. An alternate mixture comprises 35-60% water, 20-30% various synthetic detergents, 15-25% propylene glycol n-propyl ether; 5-10% propylene glycol, and up to 0.5% corrosion inhibitors, such as that specified by National Foam's product number HI-EX® 2%. Finally, a mixture comprising over 60% alpha-olefin sulfonate solution, 10-30% 2,4-pentanediol, 2-methyl-, 1-5% 1-dodecanol, and 1-5% d-limonene, such as that specified by ICL Performance Products'PHOS-CHEK® WD881 FIRE SUPPRESSANT FOAM CONCENTRATE may be used as well.

With a water:foam solution of 100:1 and with modest pressure at the inlet of the foam generator of between 70-100 pounds per square inch (psi), and at the machine of 100-120 psi, an expansion ratio for the foam of 200:1, 250:1 or even 300:1 is possible. In a larger system, 170 gallons of water per minute (gpm) can be pumped (e.g., 85/gpm at each of the foam generators, if two foam generators are used in the system). Therefore, for every gallon of water pushed through the machine, a 200× volume increase can be produced via the foam. Accordingly, a 1% foam solution at 85/gpm with 70-100 psi at the inlet of the foam generator creates approximately 8500 cfm of foam. Foam generators may be used with an Underwriters Laboratories-listed non-toxic foam to deliver a water-based, medium-expansion foam with small, dense bubbles that collapse in a relatively short time after being exposed to air.

Facilities to which the system and method are adaptable may include indoor or outdoor growing facilities for poultry, including for broiler and breeder chickens, turkeys, ducks, geese, pheasant, and any other live captive species of bird raised for food or as breeding stock, for the specific purpose of effecting mass euthanasia through inducing physical hypoxia, or suffocation, of these animals or flocks in the event of infection (by, e.g., pathogenic avian disease). The system produces foam of the requisite height, density, and bubble size to trigger physical hypoxia in these animals, resulting in a blockage of the glottis and resulting in a quick, painless death. This so-called “tracheal occlusion” has been documented in multiple tests and demonstrations by researchers, including poultry extension specialists from the University of Delaware and the University of Maryland, and whose work has incorporated post-mortem examinations of multiple birds euthanized by this method. Due to the desirable property of the foam's “dwell-time,” where the foam remains a stable blanket for a period of time, the system is adaptable for use as a chemical foam dispensing system for the cleaning and disinfection of poultry facilities, for the purposes of controlling insect populations and suppressing viral contamination.

System Configuration

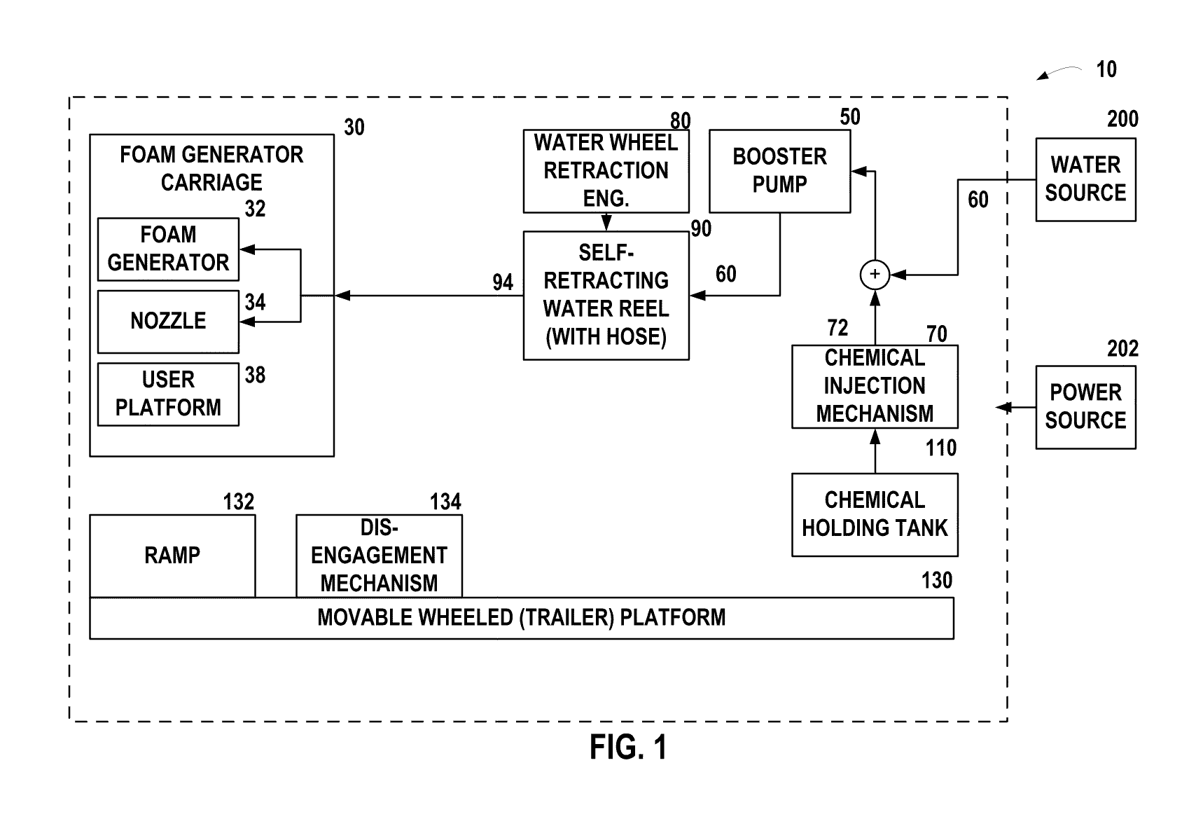

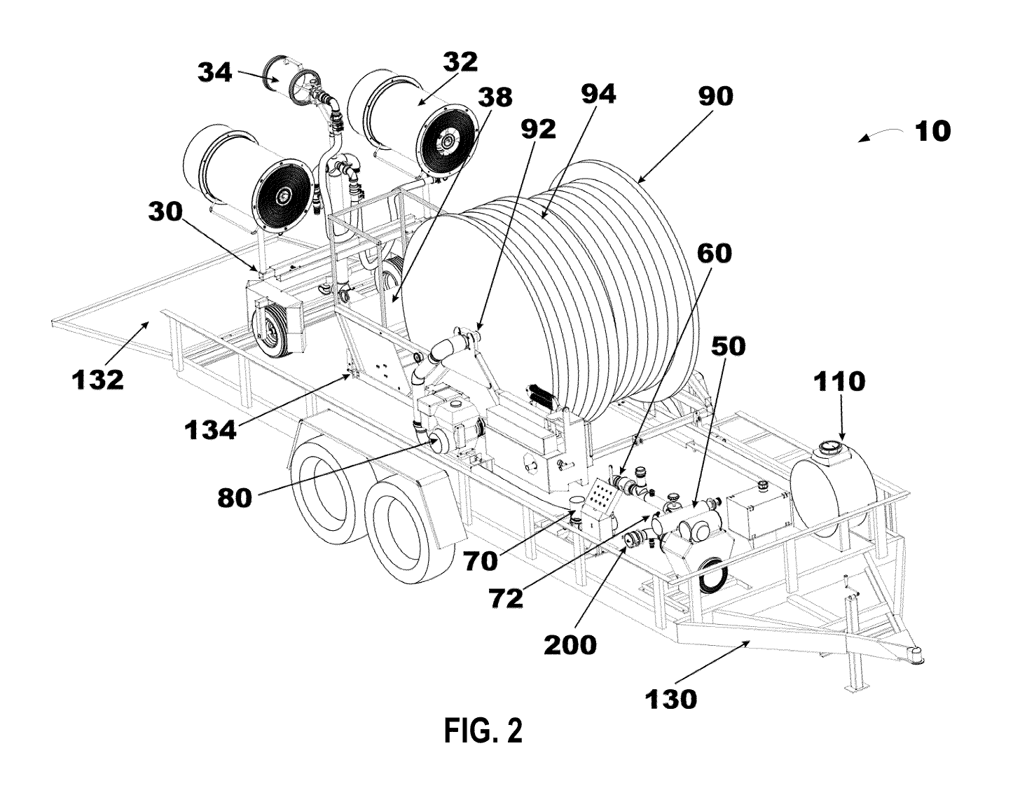

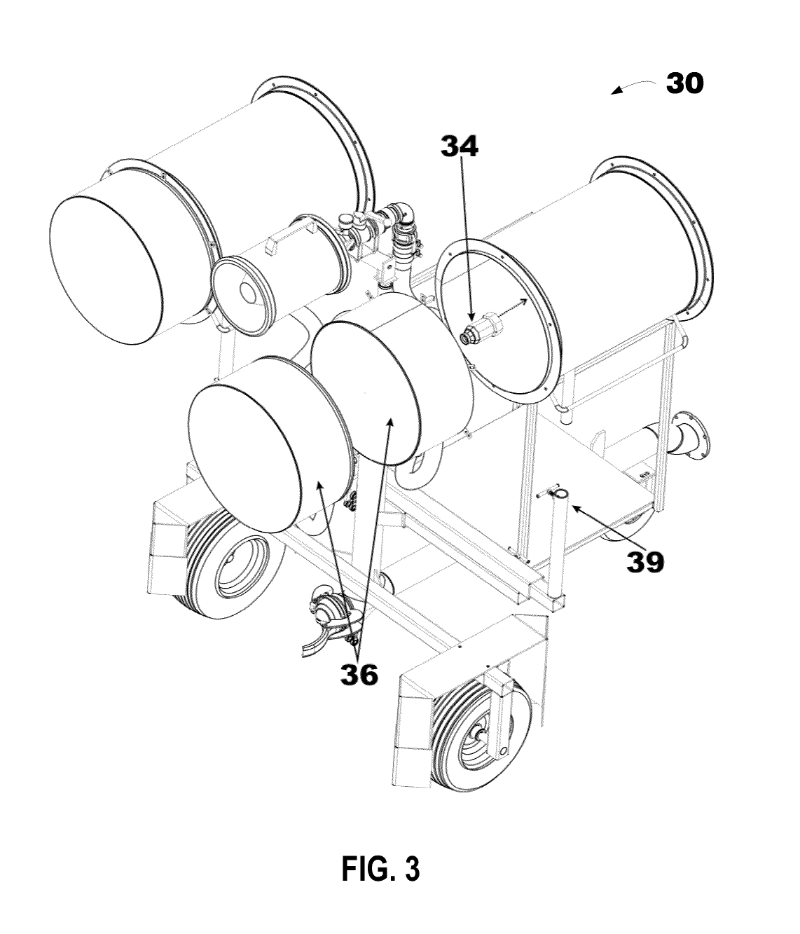

In more detail, and as illustrated in FIGS. 1 through 3, an apparatus 10 is provided for rapidly disseminating foam. The components of the system 10 are designed to fit on a movable wheeled platform 130 (e.g., a trailer) so that the system can 10 be moved rapidly to a location at which it is needed. The wheeled platform 130 is parked at an end point of the area to have foam applied in, and the foam generator carriage 30 is positioned at a start point of said area, with the foam mix supply line connecting the two. The foam-generating carriage 30, which contains foam generator(s) 32 and a user platform 38 upon which the user stands, is thus physically deployed from the wheeled platform 130 during operation. “Deployed”, as used herein, means that it is not rigidly affixed to the platform 130, but still may be tethered to components that are affixed to the platform via the hose 94. In a preferred embodiment, no power cord to the foam generators and/or nozzles, is necessary, since these may be powered hydraulically by the pressure in the water delivery hose.

The system includes a pump 50 that boosts the water pressure from an external water source 200. Such a pump 50 is preferably an internal combustion engine-driven water-pressure booster pump, although other types of known pumps may be utilized as well.

A chemical injection mechanism 70, which is, e.g., a variable flow chemical pump, is connected to a chemical holding tank 110 or barrel and may have its injection line 72 plumbed directly into a main water line 60 before entering the booster pump 50. The variable flow chemical injection pump is ideal, due to the need to change the volume of injection according to varying conditions.

A rotating water-reel drum 90, which is preferably steel-framed, may be mounted on the wheeled platform, and is connected to the main water line 60. The rotating drum 90 is mounted with a hose 94, which, in a preferred embodiment, is a large-gauge internal diameter polyethylene hard-hose with, ideally, an internal diameter (I.D.) of not more than 4″ and not less than 2″, and is driven by a water reel retraction mechanism 80, which is preferably an internal combustion engine. The use of a hard hose is important due to the towing weight of the carriage and foam generators; with a soft hose it is much more difficult to allow for self-rewinding or to allow for consistent delivery of the water-foam mix to the foam generators while it is still wound on a reel. The soft hose stretches under tension and collapses without pressure. Together, these characteristics prevent its being “wound” on a reel while still carrying water.

A foam-generator carriage 30 is provided with one or more foam production mechanisms which can include pressure-driven fan-type foam generators 32 and/or pressure-driven foam nozzles 34; these may be attached on a swivel mount 39 permitting some limited aiming of the foam output. Both foam generators and foam nozzles create foam through a combination of the chemical solution, the high water pressure created by the pump, and the combination of perforated steel and other mesh screens on the generators and/or nozzles, which force water and air together at significant pressure, creating the foam bubbles.

The movable wheeled platform 130 containing the components shown in the dashed box in FIG. 1 is positioned at one end of a poultry growing facility. The foam generator carriage 30, connected to the platform components via the foam fluid supply line 94, is towed off the platform 130 and into position at a start location area. This positioning can be done either by moving the trailer 130 while the carriage 30 remains stationary, or can be done by moving the carriage 30 while the trailer remains stationary. In either case, this action unrolls the polyethylene hard-hose 94 to a length which practically can be up to 680 feet or possibly more.

With the foam-generator carriage 30 thus positioned, the chemical injection pump 70 is switched on and primed and the two internal combustion engines—one on the booster pump 50, the other on the water-reel 80—are turned on. With the power on, water taken into the booster pump 50 is driven through the plumbed main water line 60. The foam chemical agent stored in the chemical holding tank 110 is injected into the main water line 60 by the injection pump 70 at a pre-determined rate to create an optimal foam chemical-to-water solution.

This water-foam solution (hereafter, the “solution”) is driven by water pressure through the main water line 60 to the polyethylene hard-hose 94 mounted on the water-reel 90, and then to the foam generators 32. As the solution reaches the generators 32, the water pressure and water volume combine with specially designed mesh screens 36 to be dispensed through the generators.

Exemplary volumes in a medium-volume design would involve utilizing approximately 85 GPM to produce an amount equal to or more than 2,250 ft³/min. of foam. In such a system, a 31 HP booster pump 50 with a 6 gal. fuel tank may be used. This design might use a single foam generator 32 with a KIFCO Flexi-Mesh screen. In a large volume design, two such foam generators 34 could be used and 170 GPM of water would be used to produce an amount equal to or more than 4,500 ft³/min. of foam. In this design, a 31 HP booster pump with a 6-gal fuel tank 50 could be utilized.

Chemical usage depends on the percentage of chemical injected into the water. At an optimal injection flow rate of 1%, the chemical injection pump will be set at 0.85 gallons per minute (GPM) for a system using one 85 gpm foam generator, and will be set at 1.7 GPM for a system using two 85 gpm foam generators.

Once the required volume of foam has been delivered at one end of the facility, including achieving the requisite height to suffocate infected animals, the equipment's operator uses the controls on the equipment's trailer to commence retraction of the water-reel 90, by engaging the retraction engine, which then automatically retracts the foam-generator carriage 30 through the full length of the facility. The rate of retraction, which affects the foam height achieved, is controlled at e.g., a two-speed gearbox mounted to the water-reel, or alternatively by adjusting a throttle on the retraction engine.

As the foam generator carriage 30 approaches the trailer platform 130, the entire carriage assembly 30 self-rewinds up the rear tailgate ramp 132 of the trailer platform 130. Once fully retracted, the carriage 30 hits a retraction stop bar that automatically disengages the automatic rewind mechanism.

Method for Manufacture of Apparatus

The method for producing an apparatus as described above, according to a preferred embodiment, includes adapting a specially constructed steel-framed generally large water reel 90 that is large enough to hold the entire hose 94 length for use on a self-mounted platform 130, and mounting on the water reel 90 a large-gauge, medium-density, polyethylene hard-hose 94 with e.g., an internal diameter of not more than 4″ and not less than 2″.

A water booster pump 50, which may be an internal combustion gasoline engine, is positioned to a main water feed-line 60 with the requisite fittings and valving to assure compatibility with a range of water supplies 200 that could include fire trucks, tankers, pools, municipal water mains, and other natural or manmade water sources. A variable rate chemical injection pump or other chemical injection mechanism 70 is provided, preferably affixed to the platform 130, to pump the chemicals from a liquid chemical reservoir 110 into the main water line 60, before the water booster pump 50 and before the main water line 60 enters the water-reel 90, thus assuring the optimal mixture of foam chemical to water (i.e., the “foam solution”).

The method further comprises attaching the foam-generator trolley or “carriage” 30 to the water-reel 90 via the polyethylene hard hose 94 and requisite fittings. Then, one or more drum-type, fan-driven foam generators 32 and/or pressure-driven conical foam nozzles 34 are mounted on the foam generator carriage 30 while ensuring that a necessary combination of water pressure, water volume, fan speed, perforation screen 36, and/or nozzle configuration combine to create a foam of the requisite density to precipitate a tracheal occlusion in poultry, thus inducing physical hypoxia.

Method of Operating

The method of deployment for introducing foam into a commercial facility for the poultry includes initially opening the doors of a commercial facility at one end (the near end), then towing or moving into position at the other (far) end the trailer 130, which holds the system 10, while ensuring the poultry remains inside (which may be done using a silt-fence or the equivalent).

According to the method, a water source 200 is connected, via a hose and the requisite fittings, to the main water intake line 200 on the system 10, ensuring that the flow valve on the feed line from the booster pump 50 is closed. Next, a resistance brake on the water-reel 90 is engaged to prevent “free-wheeling” of the reel 90 as it unfurls the hard hose 94 when the foam generator carriage 30 is towed into the facility.

The method comprises towing the foam generator carriage 30 off the trailer platform 130 of the system 10, pulling it through the full length of the facility, and unhooking a tow cable and winch, and then disengaging the resistance brake on the drivetrain of the water-reel 90. Then, the chemical injection mechanism 70 is switched on and primed, with the variable injection rate on the chemical injection mechanism/pump 70 set to assure an optimal percentage for the foam solution. Then the booster pump is started and primed, the flow valve on the main water line, and the internal combustion engines powering the water-reel retraction 80 is turned on.

The method then comprises opening the flow valve on the main water supply line 60 and engaging the water booster pump 50. The variable injection rate on the chemical injection mechanism/pump 70 is set to assure an optimal percentage for the foam solution. With the valves open on the foam generator and/or nozzle 32, water pressure drives the pressure at the foam head (i.e., at the foam generators 32 and/or foam nozzles 34) thereby generating the foam. A smaller foam nozzle, called a “Spumifer” nozzle, may also or alternately be used; this piece of equipment is significantly smaller than the foam generators.

The water reel retraction mechanism engine 80 is engaged to begin retraction of the foam-generator carriage 30 through the facility. The retraction mechanism 80 begins rotating a drum, which is a part of the water-reel 90, which begins coiling the attached hose 94, pulling the carriage 30 towards the trailer 130 on which the reel 90 is mounted.

In the preferred embodiment, the method may include having a user stand on a user platform 38 of the carriage 30 as it is being pulled through the facility, the user monitoring foam output, height, density, and bubble size during retraction. Alternatively such monitoring can be done by the operator at the control panel at the wheeled platform who, as necessary, may adjust the retraction speed, water pressure, rate of injection of foam chemical, and water volume as needed to achieve desired results. In an alternate embodiment, a remote operated steering mechanism may be added to the carriage 30.

When the carriage 30 is near the end of the facility, the method includes guiding the carriage 30 toward and up a ramp 132 of the trailer 130.

Once the carriage 30 has mounted the ramp 132 to the trailer platform 130, the method comprises disengaging retraction engine 80, switching off the booster pump 50, and shutting down the chemical injection pump 70 after the carriage 30 triggers the disengagement mechanism 134. The disengagement mechanism 134 uses a physical contact bar or brake to disengage the retraction mechanism, or other known mechanisms that could determine if the carriage 30 is in a particular position with respect to the trailer platform 130.

To avoid potential contamination, the method may also comprise rinsing and/or pressure-washing the carriage 30, water-reel 90, wheels, hard-hose 94, and any other portion that may have been exposed to contamination, during and/or after retraction.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The present invention may be described in terms of functional block components and various processing steps. Such functional blocks may be realized by any number of hardware components configured to perform the specified functions. The present invention could employ any number of conventional techniques for mechanical configuration, valving and plumbing, electronics configuration, signal processing and/or control, data processing and the like.

The particular implementations shown and described herein are illustrative examples of the invention and are not intended to otherwise limit the scope of the invention in any way. For the sake of brevity, conventional aspects may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

### TABLE OF REFERENCE CHARACTERS

10 foam disseminating system or apparatus
30 foam generator wheeled carriage
32 foam generator
34 foam nozzle
36 mesh generator screens
38 carriage user platform
39 swivel mount
50 water pressure booster pump
60 main water line
70 chemical injection mechanism (or pump)
72 chemical injection line
80 water reel retraction mechanism
90 water reel
94 hard hose
110 chemical holding tank
130 movable wheeled (trailer) platform
132 trailer tailgate ramp
134 foam generator wheeled carriage disengagement mechanism
200 water source
202 retraction engine

What is claimed is:

1. A system for rapidly deploying a generated foam over an area, comprising:
a movable wheeled platform for transporting the system;
a movable foam generator carriage that comprises a foam dispersion mechanism that is at least one of a foam generator and a nozzle, the foam generator carriage being separable from the movable wheeled platform;
a retractable water reel comprising a hose coiled about it, the reel being affixed to the wheeled platform, and the hose being connected to the foam dispersion mechanism when the carriage is separated from the wheeled platform;
a water line connecting a water source to an input of the retractable water reel; and
a chemical injection mechanism that injects foam-producing chemicals into the water line in a predefined ratio, wherein the chemicals and water are provided to the foam dispersion mechanism through the water reel and hose.

2. The system according to claim 1, wherein the platform is a trailer comprising a connection for connecting it to a powered transportation vehicle.

3. The system according to claim 1, wherein the platform further comprises a rear tailgate ramp upon which the carriage travels.

4. The system according to claim 3, wherein the platform further comprises a retraction stop mechanism located near an end portion of the rear tailgate ramp that can interact with the carriage.

5. The system according to claim 1, wherein the foam dispersion mechanism comprises a pressure-driven fan-type foam generator.

6. The system according to claim 5, wherein the foam generator comprises a mesh or perforated element through which the combined chemicals and water are passed.

7. The system according to claim 1, wherein the foam dispersion mechanism comprises a pressure driven foam nozzle.

8. The system according to claim 1, wherein the foam dispersion mechanism is powered solely by supplied water pressure.

9. The system according to claim 1, wherein the carriage further comprises a swivel mechanism for the foam dispersion mechanism.

10. The system according to claim 1, further comprising a water reel retraction mechanism for self-retracting the hose.

11. The system according to claim 10, wherein the water reel retraction mechanism is an internal combustion engine.

12. The system according to claim 10, wherein the water reel retraction mechanism comprises an attachment that pulls the carriage up a ramp of the movable wheeled platform.

13. The system according to claim 1, wherein the hose is a relatively hard hose.

14. The system according to claim 13, wherein the hose is made of polyethelene.

15. The system according to claim 13, wherein the hose has an inside diameter of between 2″ and 4″.

16. The system according to claim 1, further comprising a water pressure booster pump.

17. The system according to claim 16, wherein the water pressure booster pump can deliver 85 gpm of fluid flow.

18. The system according to claim 16, wherein the water pressure booster pump is powered by an internal combustion engine.

19. The system according to claim 1, wherein the chemical injection mechanism is an injection pump.

20. The system according to claim 1, wherein the predefined ratio of water to chemicals ranges between 100:1 and 300:1.

21. A method for rapidly deploying a generated foam over a containment area, comprising:
providing a movable wheeled platform at an end position of the containment area;
providing a foam generator carriage at a start position of the containment area, the carriage and the platform being separated by a distance, and connected by a hose that is initially wrapped around a retracting water reel, the water reel being affixed to the platform;
retracting the movable wheeled platform from the start position to the end position; and
pumping water and a foam-producing chemical through the hose and into a foam dispersion mechanism that is at least one of a foam generator and a nozzle, thereby producing, during the retracting, a layer of foam.

22. The method according to claim 21, further comprising engaging a water booster pump for pumping the water.

23. The method according to claim 21, further comprising adjusting, during the retracting, a parameter of operation by an operator.

24. The method according to claim 22, wherein the operator is riding on a platform of the carriage.

25. The method according to claim 21, wherein the retracting comprises pulling on the hose by the water reel.

26. The method according to claim 21, wherein the retracting utilizes an internal combustion retraction engine.

27. The method according to claim 21, further comprising swivelling the foam dispersion mechanism during the retracting.

28. The method according to claim 21, further comprising driving the water and chemical through a mesh or perforated element of the foam dispersion mechanism.

29. The method according to claim 21, further comprising driving the foam dispersion mechanism solely with water pressure.

30. The method according to claim 21, further comprising applying a resistance brake to the water reel during an unfurling operation.

31. The method according to claim 21, further comprising mixing the water and the foam-producing chemical by injecting the foam-producing chemical with an injection pump into a water flow with a variable injection rate to ensure an optimal mixture.

32. The method according to claim 21, further comprising moving the carriage up a ramp of the trailer to move the carriage onto the platform.

33. The method according to claim 32, further comprising performing a shut-down operation when the carriage has finished moving up the ramp.

34. The method according to claim 33, wherein the shutdown operation comprises:
stopping a retraction engine utilized to retract the hose;
stopping an injection pump utilized to inject the foam-producing chemical; and
stopping a water pressure booster pump utilized to pump water.

35. The method according to claim 21, wherein the containment area is a house or pen used to hold animals; the method further comprising:
inducing physical hypoxia in the animals within the containment area in order to euthanize them.

36. A method for manufacturing an apparatus for depopulating an animal containment area, comprising:
providing a movable wheeled platform;
attaching a water reel to the platform with a high-strength metal frame;
mounting a relatively large internal diameter hose onto the water reel;
attaching a water booster pump onto the platform and attaching its output to a main water line;
attaching a chemical injection mechanism to the platform and attaching its output to the inlet line of the pump;
connecting the main water line from the pump to the water reel hose;
providing a movable and detachable foam generator carriage having a foam dispensing mechanism that is at least one of a foam generator and a nozzle on the platform; and
connecting an output of the hose to an input of the foam dispensing mechanism to provide the foam-water solution to it.
